(19) United States
(12) Patent Application Publication
(10) Pub. No.: US 2002/0083447 A1
(43) Pub. Date: Jun. 27, 2002

(54) Television services

(75) Inventors: Dale R. Heron, Crawley (GB); Timothy J. Everett, Thaneham (GB); Richard M. Miller-Smith, Lingfield (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/023,110

(22) Filed: Dec. 17, 2001

(30) Foreign Application Priority Data
Dec. 27, 2000 (GB) 0031615.8

(51) Int. Cl. H04N 5/445

(52) U.S. Cl. 725/38

(57) ABSTRACT

Digital television receiving equipment is provided with access to the Internet for downloading multimedia material relevant to a forthcoming television broadcast. This means that the multimedia material is locally cached for near instantaneous user access by a viewer during the actual television broadcast therefore avoiding any delay that could otherwise occur if real-time access to the Internet were to be attempted. Information on advance television broadcasts may be made available to the receiving equipment by an electronic programme guide. The electronic programme guide may include references to information located on the Internet relevant to forthcoming television broadcasts.

This invention relates to a method and apparatus to provide improved television services.

A set top box is a piece of apparatus commonly used to receive television broadcasts, typically from satellite, cable or terrestrial transmissions. With the rapid expansion of Internet services, linkage of a set top box (STB) to the Internet is already known. A connection to the Internet is established using the STB which includes an Integrated Receiver/Decoder (IRD). A television or other display device is connected to the STB for viewing STB output, although STB functionality can be built into the television set or display. Such connections allow an association to be made between television programmes or advertisements and multimedia content present on the Internet, for example films, images, three dimensional models, audio samples, web pages, JAVA applications. Viewers can choose to view the additional information while watching a television programme or advert.

However, the speed of information retrieval from the Internet is unpredictable.

An additional service which can be provided for a viewer by a STB is the facility of an Electronic Programme Guide (EPG). Viewers have an interactive channel guide showing a selection of information about current and future TV programmes. Several software programmes to provide EPGs are commercially available for implementation on a STB, as described at http://www.managingchange.com/mediums/inter-tv/epg.htm (viewed Nov. 3, 2000). This page suggests that an EPG may be provided, for example, to allow viewers to view available programmes by subject, date, time, to obtain background information on their favourite actors and build personal lists of programmes to watch in the days ahead and remind the user when those programmes are about to start. The page also suggests that more advanced STB's and EPG's could allow personalised profiles to be stored and then used to identify likely programmes of interest.

In the context of the analogue television domain, documentation at http://www.cpb.org/research/infopackets/packet32.html (viewed Apr. 4, 2000) mentions the possibility of embedding data in the video blanking interval (VBI), horizontal over scan or in the video itself, of television broadcasts. The document further discusses the possibility of using the VBI of an analogue television signal for providing data-cast services. While the VBI has been formerly used to set the clock of a video recorder or closed captioning, use of the VBI to carry data for sending to a video decoder card and software decoder tuned to specific broadcasts opens up the possibility of providing users with programme streams carrying business and consumer services such as those of quote.com. The possibility of providing Web pages by VBI datacast was also explored. However, there are problems with VBI datacasting because of the nature of programme distribution techniques which can sometimes strip out all VBI data from the television programme as it travels through television station networks before reaching the viewer. One proposed solution is the provision of a data cache server at broadcast stations which would capture VBI datacast information and then schedule local insertion into the appropriate broadcasts.

In one specific example arrangement described in the above mentioned document, a STB receiver is provided with a video blanking interval data decoder. On reception of analogue television broadcasts carrying embedded data in the VBI, the receiving equipment detects the presence of such embedded data causing an on-screen icon to be generated which indicates to a viewer the existence of material of possible interest on the world wide web. Clicking on the link causes the establishment of a modem connection to access the producers or advertisers web site for real time viewing. It is envisaged that in the future the cross over to such material will be ‘immediate’ with the text of the above mentioned documentation reciting that ‘the viewer [is] presented with a set of screens whose content is relayed directly from the hard disk where it has been pre-loaded either during the start of the programme or in the early hours of the morning . . . .’ The discussion is restricted to the analogue domain and gives no indication of how material for pre-loading is selected or how the mechanism of such pre-loading operates.

Furthermore, problems may be encountered because the VBI information can sometimes be stripped during the local broadcast stage due to technical or political reasons.

It is an object of the invention to provide a method and apparatus allowing supply to a set top box or the like of Internet-based material or other material in a more satisfactory manner than is currently possible.

According to the present invention there is provided a method of providing multimedia services to digital television receiving apparatus characterised by the steps of:

providing to the receiving apparatus advance information related to the scheduled broadcast time of material to be broadcast;

causing the receiving apparatus to connect to the server in advance of the scheduled broadcast time to receive multimedia material related to the material to be broadcast from a source of such multimedia material; and

causing that material to be cached.

The method may further comprise the step of providing an indication during broadcast of the said material to be broadcast that additional multimedia material is available. Optionally the indication may be a visual one allowing a user to be alerted by providing such a visual indication on a display screen or by the provision of an indicator lamp on housing of equipment. Other possible types of indication include an audible sound or a tactile indication such as by means of a vibrating control device.

In the case that the material to be broadcast is a scheduled television programme or an advertisement to be broadcast during a scheduled programme then the advance information may be provided to the receiving apparatus by an electronic programme guide facility.

Also according to the present invention there is provided digital television receiving apparatus comprising:

interface means for connecting to an information resource; and

storage means, characterised in that the receiving apparatus is configured to receive in advance information related to the scheduled broadcast time of material to be broadcast and to connect via the interface means to the information resource in advance of the scheduled broadcast time to receive multimedia material from the information resource related to the material to be broadcast and to cache said received multimedia material in the storage means.

The apparatus may further comprise indicator means to provide an indication during broadcast of the programme to which the material relates that additional multimedia material is available, and to provide access to the additional material at the viewers option.

Also in accordance with the present invention there is provided a digital television set comprising world wide web interface means and a set top box facility, characterised in that the set top box is arranged to send advance enquiry messages via the Internet for any programme-related multimedia material; to cause such material to be cached in the set; to provide a visual indication during broadcast of the programme to which the material relates that additional multimedia material is available, and to provide access to the additional material at the viewers option.

Other aspects and optional features of the present invention appear in the appended claims which are incorporated herein by reference and to which the reader is now referred.

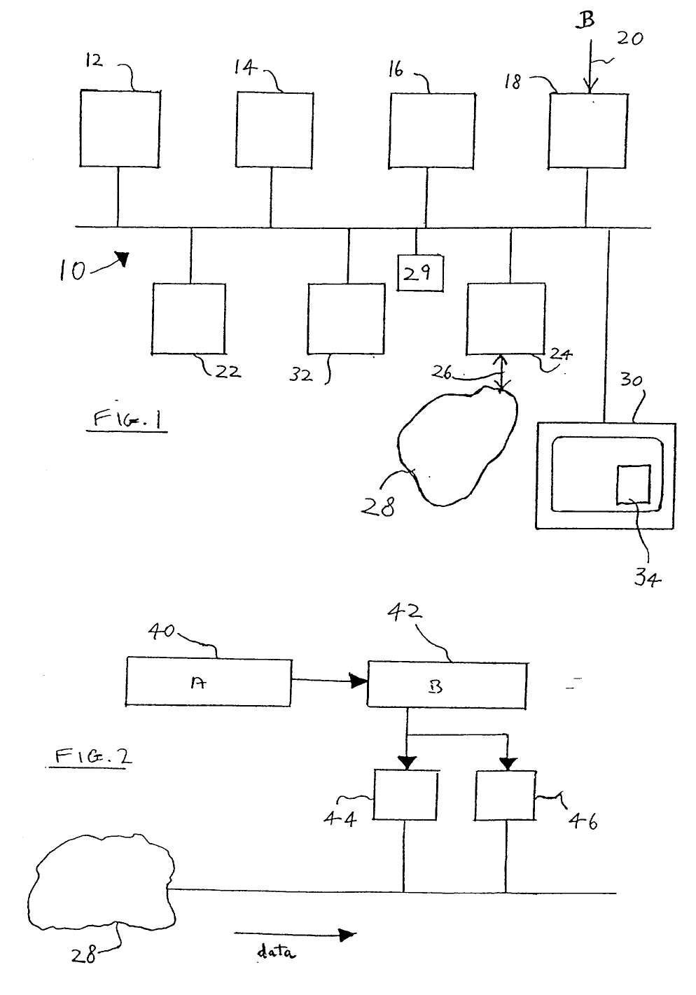

The invention will now be described by way of example only with reference to FIGS. 1 and 2 of the accompanying drawings in which:

FIG. 1 illustrates in highly schematic form of set top box facility and display device; and

FIG. 2 illustrates the flow of data during one example of operation of the invention.

In FIG. 1 the main components of digital television receiving apparatus in the form of a set-top-box (STB) 10 comprise a central processing unit CPU 12; a random access memory RAM 14; a read only memory ROM 16; a receiving device 18 which receives signals from a broadcaster as indicated by the arrow 20; a video display generator unit VID 22 and an interface 24 connectable by a two way link indicated by the arrow 26 to server derived multimedia services by linking to a specialised server directly or to a server accessible via the Internet 28. Such services are often presented in the context of the World Wide Web (WWW). The apparatus is preferably provided with storage 29 which may take the form of a hard disc drive, writable optical disc or other read/write storage device. Output from the video display generator unit 22 is provided to display screen 30 (which may be a television set) for viewing.

Optionally the apparatus 10 also has a Conditional Access Mechanism 32, which prevents a viewer from seeing unpaid-for programmes.

An electronic programme guide (EPG) facility is accessible via the STB which displays information to the viewer about television broadcast programmes. Regularly updated data needs to be provided to the EPG to ensure that correct information about programming is displayed to the viewer. In order to obtain such data, the STB may intermittently connect through the interface 24 to a server directly or via the Internet 28 to retrieve information (optionally from an Internet site) on forthcoming television programmes. Such data may also or alternatively be provided by the broadcaster and may be embedded, for example, in a digital television broadcast stream of the signals 20 in which case the data is received through the receiving device 18. Depending on the sophistication of the EPG and the requirements of the user, the may EPG allow users to check programme availability by subject or by date and time; to provide users with background information on actors, directors, film locations and to build personal lists of favourite channels and so forth. Advanced search options may also be available.

The interface 24 may be one that connects to the server or Internet in general via the telecommunications network or so-called cable television network. Example types of interface 24 include a modem, Integrated services digital network (ISDN) adapter, or a network adapter.

In accordance with the invention, programme entries in the EPG may in addition also contain links to dedicated servers or Internet sites holding information related to or associated with the programme. Alternatively the STB may be provided with the ability to search the Internet in advance of the scheduled broadcast time for programme-related information in a broader sense, for example based on words or phrases contained in entries of the electronic programme guide. In either case the STB then downloads and stores locally the information of interest in a cache type operation. The information is then available locally in time for when the television programme or advert with which the information is associated with is actually broadcast. The data may be cached on hard disc, in memory or any suitable storage means such as optical disc as will be appreciated by the person skilled in the art.

For example, a broadcaster may want to provide viewers with additional information about a particular TV programme, such as a soap opera. The broadcaster puts that additional information on the Internet. The EPG specifies the existence of and location of material to be cached by the STB. During a programme or advertisement for which associated information exists, the STB causes an icon to be shown to indicate that additional multi-media material is available. If the viewer wishes to see such material instead of or as well as the programme or adverts, the STB causes it to be displayed on the display screen 30. The viewer can choose whether to view the additional material simultaneously with the broadcast on a split screen, as an overlay that is either transparent or opaque, or as a screen insert 34 as shown in FIG. 1. The viewer appears to have virtually instantaneous access to the associated information without the delay so characteristic of Internet access.

In a variation, there may be multiple sets of associated information which the broadcaster wants viewers to receive. For example consider three sets of web pages where the broadcaster would like the viewer to look at the first set before the programme is broadcast; the second set during an advert break in the broadcast; and the third set when the programme has finished. The three sets of pages are given time-locks based on time of day to ensure that the web pages cannot be viewed before the assigned times. All three sets are cached before the broadcast with the time locks included in the cached material. The viewer can chose to view each set, but not in advance, for the second and third sets. Encryption mechanisms may be required for correct operation of such a scheme.

In practise, although the expression ‘time-locked’ is employed, the moment for allowing access to the information may be related to the broadcast time of the television programme as opposed to absolute time. In order to accommodate deviations of actual programme broadcast time in comparison with planned broadcast time, the trigger to ‘unlock’ the time lock material may be relayed to the STB by the broadcaster in television broadcast signals 20 or via a communications network, such as by telephone link, via interface 24.

In these examples, the multimedia content can be located in a dedicated server devoted to the soap opera, and the EPG is provided with a key pointing to that server.

In another example, an advertiser may be advertising a particular toy a few weeks before Christmas. The advertiser puts on the Internet information about the toy additional to the television advertisement, for example a three dimensional image and sound information, and associates a pointer to the information location on the internet i.e. associates it to a programme during which the advert will be broadcast. The EPG causes location, download and storage of this information i.e. a local caching process. During viewing of the programme an icon indicates additional multi media material is available, and the viewer can chose whether to view the multimedia material simultaneously with the broadcast on a split screen, as an overlay either transparent or opaque, or as a screen insert 34 as shown in FIG. 1.

As an alternative to the EPG providing the location of Internet material to be retrieved, a programme provider or advertiser can provide the advance information to drive the search.

In this arrangement the data flow is illustrated in FIG. 2. An advertiser 40 provides advertising information and payment to a broadcaster 42 who makes scheduling information available to the STBs 44, 46 . . . . The advertiser 40 also puts advert-related multimedia material on the Internet 28, which is accessed by the STBs 44, 46 in advance of broadcasting of the advert.

The multimedia data placed on the Internet by the advertiser or broadcaster can be addressed by codes such as a single URL (Uniform Resource Locator) although of course one URL can be used to access several web pages, several three dimensional models etc. The single URL is inserted into the broadcast stream in the designated place, as is the case with the well-known Teletext service, to indicate when the icon should be displayed. Codes can also be added to indicate to the STB when to access the multimedia material available for downloading, and how long to keep it cached. Alternatively, the EPG trigger information can be included in the broadcast stream, e.g. digital MPEG 2.

Conveniently, the STB is arranged to connect to the web so as to cache required information at a time when the television set 10 is not likely to be in use, such as in the early hours of the morning.

In yet another example, the STB is arranged to cache any web pages related to the viewer's ten favourite programmes. The STB can be automated to work out the ten favourites, or the viewer can select them and input them manually. The cached favourites can be offered to a viewer when-he begins to surf the web.

In a variation, a viewer may manually set priorities for a number of URLs, or the STB may use automatic profiling of the viewer to set the priorities, and the STB then searches the web automatically for the appropriate URLs.

In yet another variation, third parties may be employed to surf the web for information about certain programmes, and the STB can be operated accordingly. For example, if the EPG indicates to the STB that a particular soap is to be broadcast, the STB needs to know where to look for related multimedia. One solution is to cause the STB to query a server on the Internet for a list of URLs related to that soap, preferably the best such sites. A third party can be paid to create such a list, and to update it.

It will be clear from the examples that the STB will ideally have the capability to deal any variety of multimedia material that needs to be handled, such as three dimensional rendering of an article that is to be advertised. Preferably the STB must be capable of handling JAVA applets. To assist with such requirements the STB may be provided with the capability of downloading software to update the STB as software usage and standards evolve.

A URL to be used according to the invention may be given a particular characteristic or may be sent in a particular manner so as to provide a very high probability of data being downloaded, i.e. of the viewer choosing to click onto the additional multimedia material. Such a URL could provide additional satisfaction to an advertiser.

In certain circumstances, it may be necessary to take measures to ensure that broadcast times indicated in an electronic programme guide are suitable for use within, or at least adapted for use within, a particular time zone. Where the EPG is provided by a cable television company for use by its subscribers in a particular region, any need for time synchronisation may be met by the provider. In other instances, such as where the EPG content is provided by a third party over the Internet, it may be necessary to provide a mechanism for providing conformity between EPG programme listing times and local time and this may be done in a number of different ways as will be appreciated by a person skilled in the art, such as providing EPG content peculiar to a particular time zone or by translating EPG time listing within the STB to reflect the local time. This may also be the case where received and cached multimedia content is time-locked, as described above.

Although the multimedia content may be received via interface 24, it may alternatively be received via the television broadcast stream 20, which may be favourable where there is a high expectation of demand for multimedia content associated with a forthcoming television broadcast which is known to be a popular choice for viewers.

The multimedia content may be derived from sources such as Internet sites that specialise in information relating to a particular subject, for example the site entitled ‘The Internet Movie Database’ located at http://www.imdb.com. The site provides a large film catalogue that is searchable by criteria including title, film characters, actors, quotes and so providing a readily available reference source for many films.

The information for the EPG may be carried in a broadcast stream, such as digital MPEG 2. The broadcast stream may carry a relatively diverse selection of information.

Although the above examples describe the present invention in the context of digital television receiving apparatus and set-top-boxes it will be apparent to the person skilled in the art that functional component parts of the invention may be incorporated within a single item of equipment such as a digital television receiver or distributed across a number of items of equipment, without departing from the scope of the present invention.

From reading the present disclosure, other modifications will be apparent to persons skilled in the art. Such modifications may involve other features which are already known in the design, manufacture and use of set-top-box receivers, digital television, electronic programme guides, data caching, multimedia and applications thereof and which may be used instead of or in addition to features already described herein.

1. A method of providing multimedia services to digital television receiving apparatus characterised by the steps of:
providing to the receiving apparatus advance information related to the scheduled broadcast time of material to be broadcast;
causing the receiving apparatus to connect in advance of the scheduled broadcast time to receive multimedia material related to the material to be broadcast from a source of such multimedia material; and
causing that material to be cached.

2. The method of claim 1 and further comprising the step of providing an indication during broadcast of the said material to be broadcast that additional multimedia material is available.

3. The method of claim 2 wherein the indication is visual.

4. The method of claim 1 in which the material to be broadcast is a scheduled television programme or an advertisement to be broadcast during a scheduled programme and the advance information is provided to the receiving apparatus by an electronic programme guide facility.

5. The method of claim 1 in which the material to be broadcast is a television programme or an advertisement and the advance information is provided to the receiving apparatus by a broadcaster.

6. The method of claim 1 in which the advance information relates to a pre-determined number of the viewer's favourite programmes.

7. The method of claim 1 wherein the multimedia material is received via the Internet and in which the availability of multi-media material is indicated by a URL.

8. The method of claim 7 and further comprising the step of providing an indication during broadcast of the said material to be broadcast that additional multimedia material is available, wherein said URL is inserted into a broadcast stream to determine when said indication is to be provided to the viewer.

9. The method of claim 1 in which the multi-media material is viewable simultaneously with the broadcast programme or advertisement by means of a split screen or screen insert.

10. The method of claim 1 wherein received and cached multimedia material related to the material to be broadcast is time-locked so as to be available to a viewer only at certain times.

11. The method of claim 1 wherein the receiving apparatus has a set-top-box facility.

12. Digital television receiving apparatus comprising:
interface means for connecting to an information resource; and
storage means, characterised in that the receiving apparatus is configured to receive in advance information related to the scheduled broadcast time of material to be broadcast and to connect via the interface means to the information resource in advance of the scheduled broadcast time to receive multimedia material from the information resource related to the material to be broadcast and to cache said received multimedia material in the storage means.

13. The receiving apparatus of claim 12 and further comprising an electronic programme guide, wherein the material to be broadcast is a scheduled television programme or an advertisement to be broadcast during a scheduled programme and the advance information is provided to the receiving apparatus by the electronic programme guide.

14. The receiving apparatus of claim 12 and further comprising an electronic programme guide arranged to store information relating to forthcoming programmes, the guide being further arranged to initiate the receiving apparatus to search one or more information resource for programme-related material.

15. The receiving apparatus of claim 12 wherein the digital television apparatus is in the form of a set-top-box and further includes an output for providing an output signal to an output display means.

16. The receiving apparatus of claim 12 wherein the information resource is Internet based.
